(19) United States
(12) Patent Application Publication
(10) Pub. No.: US 2026/0150825 A1
(43) Pub. Date: Jun. 4, 2026

(54) FISHING REEL

(71) Applicant: GLOBERIDE, Inc., Tokyo (JP)

(72) Inventor: Taro IKE, Higashikurume-shi (JP)

(73) Assignee: GLOBERIDE, Inc., Tokyo (JP)

(21) Appl. No.: 19/374,112

(22) Filed: Oct. 30, 2025

(30) Foreign Application Priority Data
Dec. 4, 2024 (JP) 2024-210879

(51) Int. Cl. A01K 89/015

(52) U.S. Cl. CPC A01K 89/01903

(57) ABSTRACT

A fishing reel according to an embodiment of the present invention comprises: a reel main body; an operating part provided on the reel main body; a spool around which a fishing line is wound by a winding operation of the operating part, the spool being provided on the reel main body; a handle drive shaft to which the operating part is attached, the handle drive shaft being provided on the reel main body; and a plurality of one-way clutches arranged side by side in an axial direction of the handle drive shaft. Each of the plurality of one-way clutches comprises an inner ring, a retainer disposed outside the inner ring, a plurality of rolling members retained by the retainer, and an outer ring disposed outside the retainer, and the inner ring is a dedicated inner ring provided for each of the plurality of one-way clutches.

### CROSS-REFERENCE TO RELATED APPLICATION

This application claims priority under 35 U.S.C. § 119 to Japanese Patent Application No. 2024-210879 filed on December 4, 2024 in the Japanese Patent Office, the entire contents of each hereby incorporated by reference.

### BACKGROUND OF THE INVENTION

### 1. TECHNICAL FIELD

The present invention relates to a fishing reel.

### 2. DESCRIPTION OF THE RELATED ART

Regarding a fishing reel including a reel main body having a handle, a spool rotatably attached to the reel main body, and the handle for rotating the spool, a structure is conventionally known in which the spool is rotated in a winding direction of a fishing line by rotating the handle to wind the fishing line around the spool.

### SUMMARY OF THE INVENTION

In relation to such a fishing reel, for example, JP 2024-85772 A discloses a fishing reel including a reel main body attached to a fishing rod, a handle provided on the reel main body so as to be rotatable, and a spool that rotates in a winding direction of a fishing line in conjunction with a rotation operation of the handle, in which a winding load reducing mechanism that reduces variation in the force to wind the fishing line occurring during the rotation operation of the handle is provided between the handle and the spool.

However, the fishing reel in JP 2024-85772 A has a structure in which two one-way clutches are provided between the handle and the spool, and an inner ring of the two one-way clutches serves as a drive shaft. Thus, torsional deformation of the drive shaft causes edge contact between the two one-way clutches and the drive shaft at two points (both ends), breakage of a rolling member in the one-way clutches, and increased load on the remaining other rolling members, which results in an issue of great deterioration in a reverse rotation preventing function of the one-way clutches.

The present invention has been made in view of the above circumstances, and an object of the present invention is to provide a fishing reel capable of, even when strong tension is generated in a spool during fishing, reducing damage of a one-way clutch provided on a handle drive shaft that eventually receives the tension force and suppressing deterioration in the reverse rotation preventing function of the one-way clutch. Other objects of the present invention will become apparent by reference to the entire specification.

A fishing reel according to an embodiment of the present invention comprises: a reel main body; an operating part provided on the reel main body; a spool around which a fishing line is wound by a winding operation of the operating part, the spool being provided on the reel main body; a handle drive shaft to which the operating part is attached, the handle drive shaft being provided on the reel main body; and a plurality of one-way clutches arranged side by side in an axial direction of the handle drive shaft. Each of the plurality of one-way clutches comprises an inner ring, a retainer disposed outside the inner ring, a plurality of rolling members retained by the retainer, and an outer ring disposed outside the retainer, and the inner ring is a dedicated inner ring provided for each of the plurality of one-way clutches.

In the fishing reel according to the embodiment of the present invention, the inner ring is non-rotatably engaged with the handle drive shaft.

In the fishing reel according to the embodiment of the present invention, the inner ring is formed of a material harder than a material of the handle drive shaft.

In the fishing reel according to the embodiment of the present invention, the inner ring has a length in a range of 5 mm to 20 mm when viewed in the axial direction of the handle drive shaft.

In the fishing reel according to the embodiment of the present invention, the inner rings of the plurality of one-way clutches are disposed such that adjacent ends of the inner rings are in contact with each other when viewed in the axial direction of the handle drive shaft.

In the fishing reel according to the embodiment of the present invention, the plurality of one-way clutches are disposed such that adjacent ends of the plurality of one-way clutches are spaced from each other when viewed in the axial direction of the handle drive shaft.

According to the above embodiment, it is possible to provide a fishing reel capable of, even when strong tension is generated in a spool during fishing, reducing damage of a one-way clutch provided on a handle drive shaft that eventually receives the tension force and suppressing deterioration in the reverse rotation preventing function of the one-way clutch.

### BRIEF DESCRIPTION OF THE DRAWINGS

FIG. 1 is a view illustrating a basic configuration of a fishing reel according to an embodiment of the present invention; and

FIG. 2 is a partially enlarged view of the fishing reel according to the embodiment of the present invention.

### DETAILED DESCRIPTION

Hereinafter, an embodiment of a fishing reel according to the present invention will be specifically described with reference to the accompanying drawings, taking a dual-bearing reel as an example. Components that are common in a plurality of drawings are denoted by the same reference signs throughout the plurality of drawings. It should be noted that each of the drawings is not necessarily drawn to an accurate scale for convenience of description.

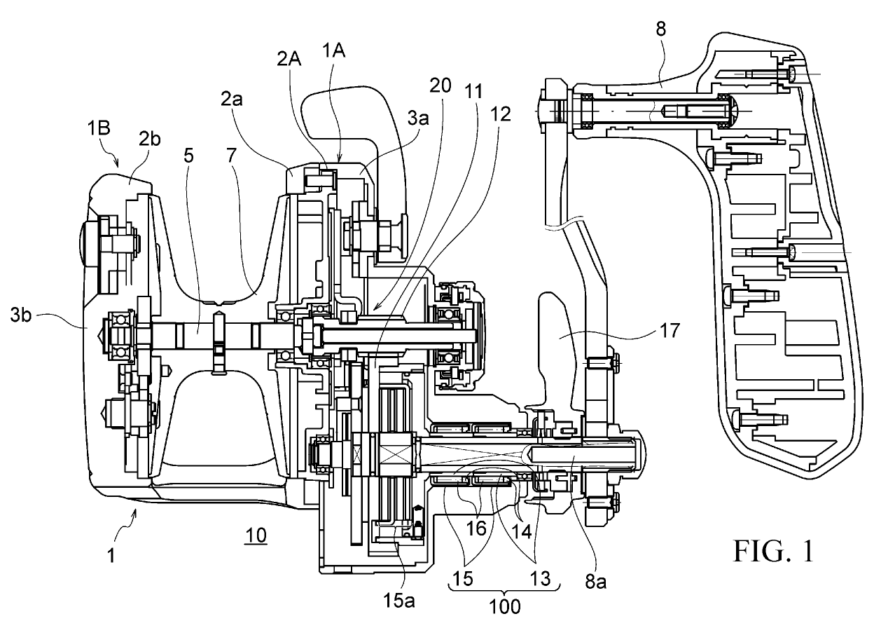

First, a basic configuration of the fishing reel according to the embodiment of the present invention will be described with reference to FIG. 1. FIG. 1 is a view illustrating the basic configuration of the fishing reel according to the embodiment of the present invention.

A fishing reel 10 according to the embodiment of the present invention comprises a reel main body 1 comprising left and right frames 2a and 2b, and left and right side panels 1A and 1B covering the left and right frames 2a and 2b with left and right side plates (left and right covers) 3a and 3b. A spool shaft 5 is rotatably supported between the left and right side panels 1A and 1B by way of a bearing (not illustrated), and a spool 7 around which a fishing line is wound is integrally fixed to the spool shaft 5. The spool 7 comprises a line winding body 7a and flanges 7b integrally formed on both left and right sides thereof, and the fishing line is wound around the line winding body 7a while being restricted by the left and right flanges 7b.

In the fishing reel 10 according to the embodiment of the present invention, a set plate 2A is provided as a constituent element of a frame structure together with the left frame 2a described above, and may be integrally attached to the left side plate (left cover) 3a. In this case, when the left side plate 3a is detached from the left frame 2a, the set plate 2A is also detached integrally with the left side plate 3a and a spool opening 2d formed in the left frame 2a can be exposed, thereby allowing easy detachment of the spool 7 and improving the maintainability.

The spool 7, which comprises the line winding body 7a and the flanges 7b integrally formed on both left and right sides thereof as described above, is configured in a substantially cylindrical shape, and allows the fishing line to be wound around the outer periphery of the line winding body 7a when being rotated forward. One of a pair of bearings (not illustrated) rotatably supporting the spool 7 is fixed to the left frame 2a of the reel main body 1, and the other is fixed to the set plate 2A.

The set plate 2A can be fixed to the left frame 2a by screwing (a screw) to be described later. Alternatively, a bayonet structure in which a plurality of claws provided on a lock member are rotated to be locked to a holding part provided on a frame 2 may be adopted so that the spool 7 and the set plate 2A can be attached to and detached from the left frame 2a. A method such as bonding may be adopted for fixing. When the set plate 2A is fixed to the left frame 2a, the spool 7 is rotatably supported on a shaft. In addition, a fixed magnet and a movable magnet (not illustrated) are held on the set plate 2A to constitute a braking part (not illustrated).

The left and right frames 2a and 2b (the reel main body 1) can be attached to a fishing rod. The fishing reel 10 comprises an operating part (handle) 8 similarly to a conventional fishing reel and can wind the fishing line when the spool 7 is rotated in a forward direction by a user operation. Note that some known functions of the reel main body are omitted in order to simplify the description.

The handle 8 that rotationally drives the spool 7 is installed on a left side panel 1A side, and a known spool-driving power transmission mechanism that transmits a rotational driving force of the handle 8 to the spool shaft 5 is disposed in a space (gear box) S between the left frame 2a and the left side plate 3a. The spool-driving power transmission mechanism comprises a drive gear 11 rotatably supported by a handle drive shaft 8a to which the handle 8 is attached, and a pinion gear 12 that is axially movably held by the spool shaft 5 and is meshed with the drive gear 11.

The handle drive shaft 8a is provided with a plurality of rolling-type one-way clutches 100. Each of the plurality of rolling-type one-way clutches 100 comprises an inner ring 13 non-rotatably engaged with the handle drive shaft 8a, a retainer 14 disposed outside the inner ring 13, and an outer ring 15 disposed outside the retainer 14. An inner peripheral surface of the outer ring 15 has a free rotation region where a plurality of rolling members 16 retained by the retainer 14 can freely rotate and a wedge region where the plurality of rolling members 16 are prevented from rotating. Each of the rolling members 16 is constantly biased toward the wedge region by a spring member provided on the retainer 14. In the one-way clutches 100 having such a configuration, forward rotation of the inner ring 13 together with the pinion gear 12 causes the rolling members 16 of the retainer 14 to be located in the free rotation region of the outer ring 15. Thus, a rotational force of the inner ring 13 is not transmitted to the outer ring 15 (not prevented by the outer ring 15), thereby allowing the handle drive shaft 8a to rotate without any hindrance. On the other hand, when the inner ring 13 tries to reversely rotate together with the handle drive shaft 8a, the rolling members 16 of the retainer 14 are located in the wedge region of the outer ring 15. Thus, a rotational force of the inner ring 13 is transmitted to the outer ring 15, and this serves as a stopper to prevent the rotation (reverse rotation) of the handle drive shaft 8a. Further details of the plurality of rolling-type one-way clutches 100 will be described later.

The drive gear 11 is provided with a known drag mechanism by which frictional engagement between the handle drive shaft 8a and the drive gear 11 generates a predetermined braking force on the drive gear. The braking force can be adjusted by rotating a drag knob (also referred to as a star drag) 17 attached to the handle drive shaft 8a and changing a pressing force of a brake plate 15a in surface contact with the drive gear 11.

The fishing reel 10 comprises a clutch mechanism (clutch means) 20, and a user can select between connection and disconnection of power transmission to the spool 7 by operating a switching operation member (not illustrated) of the clutch mechanism (clutch means) 20. In a connection state, winding by the operation means is possible. In a disconnection state, the spool 7 can be freely rotated in forward and backward directions, and the fishing line can be released.

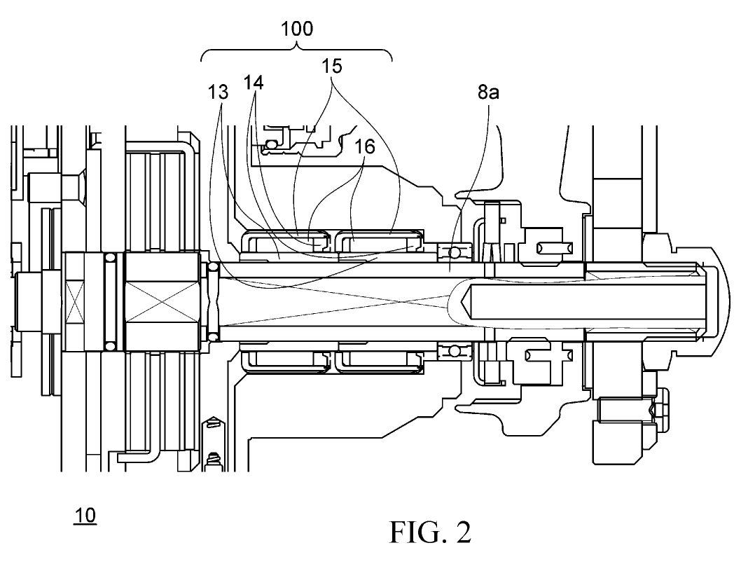

Next, the fishing reel 10 according to the embodiment of the present invention will now be further described with reference to FIGS. 1 and 2.

FIG. 2 is a partially enlarged view of the fishing reel 10 according to the embodiment of the present invention, and is a view for describing the fishing reel 10 in more detail.

As illustrated in FIGS. 1 and 2, a fishing reel 10 according to the embodiment of the present invention comprises: a reel main body 1; an operating part 8 provided on the reel main body 1; a spool 7 around which a fishing line is wound by a winding operation of the operating part 8, the spool 7 being provided on the reel main body 1; a handle drive shaft 8a to which the operating part 8 is attached, the handle drive shaft 8a being provided on the reel main body 1; and a plurality of one-way clutches 100 (two one-way clutches are illustrated in the example of FIG. 2) arranged side by side in an axial direction of the handle drive shaft 8a. Each of the plurality of one-way clutches 100 comprises an inner ring 13, a retainer 14 disposed outside the inner ring 13, a plurality of rolling members 16 retained by the retainer 14, and an outer ring 15 disposed outside the retainer 14, and the inner ring 13 is a dedicated inner ring provided for each of the plurality of one-way clutches 100. Here, the number of the plurality of one-way clutches 100 may be 2, 3, or more, and is not limited to a specific number.

According to the fishing reel 10 of the embodiment of the present invention, even when strong tension is generated in the spool during fishing, distortion of the handle drive shaft that eventually receives the tension force can be supported at two portions of the inner rings of the plurality of one-way clutches. Therefore, it is possible to provide a fishing reel capable of reducing damage of one-way clutches and suppressing deterioration in the reverse rotation preventing function of the one-way clutches. In particular, in a case where the handle drive shaft is substituted for the inner rings of the one-way clutches or in a case where a common inner ring is used for the plurality of one-way clutches, edge contact of an inner ring part due to inclination of the handle drive shaft under applied load would lead to deterioration in the function of the one-way clutches. As in the invention of the present application, providing a dedicated inner ring for each of the plurality of one-way clutches 100 separately from the handle drive shaft makes it possible to more effectively absorb the inclination caused by the load applied to the handle drive shaft and mitigate edge contact of the one-way clutches, thereby preventing the deterioration in the function of the one-way clutches.

In the fishing reel 10 according to the embodiment of the present invention, the inner ring 13 is non-rotatably engaged with the handle drive shaft 8a. In this case, the inner ring 13 portion is subject to large load during reverse rotation, and thus a material harder than that of the handle drive shaft 8a is used for the inner ring 13 portion so that damage of the inner rings can be reduced.

In the fishing reel 10 according to the embodiment of the present invention, the inner ring 13 is formed of a material harder than a material of the handle drive shaft 8a. In this manner, it is possible to reduce damage of the inner ring 13 portion subject to large load during reverse rotation.

In the fishing reel 10 according to the embodiment of the present invention, the inner ring 13 has a length in a range of 5 mm to 20 mm when viewed in the axial direction of the handle drive shaft 8a. In this manner, overall compactness can be achieved while covering the length of the rolling members 16 in the same direction, and stable attachment can be ensured.

In the fishing reel 10 according to the embodiment of the present invention, the inner rings 13 of the plurality of one-way clutches 100 are disposed such that adjacent ends of the inner rings 13 are in contact with each other in the axial direction of the handle drive shaft 8a (in the example of FIG. 2, two inner rings 13 are disposed such that adjacent ends thereof are in contact with each other when viewed in the axial direction of the handle drive shaft 8a). In this manner, a force input from the star drag to a drag washer can be transmitted on the axis of the handle drive shaft.

In the fishing reel according to the embodiment of the present invention, the plurality of one-way clutches are disposed such that adjacent ends of the plurality of one-way clutches are spaced from each other when viewed in the axial direction of the handle drive shaft. In this manner, even when load is applied in a torsion direction, the one-way clutches do not interfere with each other, which leads to reduction of damage.

The dimensions, material, and arrangement of each component described herein are not limited to those explicitly described in the embodiment, and each component can be modified to have any dimensions, material, and arrangement that may fall within the scope of the present invention. In addition, a component not explicitly described herein can be added to the described embodiment, or some of the components described in the embodiment can be omitted.

What is claimed is:

1. A fishing reel comprising: a reel main body; an operating part provided on the reel main body; a spool around which a fishing line is wound by a winding operation of the operating part, the spool being provided on the reel main body; a handle drive shaft to which the operating part is attached, the handle drive shaft being provided on the reel main body; and a plurality of one-way clutches arranged side by side in an axial direction of the handle drive shaft, wherein
each of the plurality of one-way clutches comprises an inner ring, a retainer disposed outside the inner ring, a plurality of rolling members retained by the retainer, and an outer ring disposed outside the retainer, and
the inner ring is a dedicated inner ring provided for each of the plurality of one-way clutches.

2. The fishing reel according to claim 1, wherein the inner ring is non-rotatably engaged with the handle drive shaft.

3. The fishing reel according to claim 1, wherein the inner ring is formed of a material harder than a material of the handle drive shaft.

4. The fishing reel according to claim 1, wherein the inner ring has a length in a range of 5 mm to 20 mm when viewed in the axial direction of the handle drive shaft.

5. The fishing reel according to claim 1, wherein the inner rings of the plurality of one-way clutches are disposed such that adjacent ends of the inner rings are in contact with each other when viewed in the axial direction of the handle drive shaft.

6. The fishing reel according to claim 1, wherein the plurality of one-way clutches are disposed such that adjacent ends of the plurality of one-way clutches are spaced from each other when viewed in the axial direction of the handle drive shaft.
